(19) United States
(12) Patent Application Publication
(10) Pub. No.: US 2003/0122332 A1
(43) Pub. Date: Jul. 3, 2003

(54) Wheel chair with monocoque-type body

(76) Inventors: Bernd Engels, Albstadt (DE); Stefan Lippert, Stuttgart (DE); Jorg Sattele, Balingen (DE); Thomas Birmanns, Balingen (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/202,606

(22) Filed: Jul. 25, 2002

(30) Foreign Application Priority Data
Jul. 26, 2001 (DE) 101 36 369.9

(51) Int. Cl. B62B 7/00

(52) U.S. Cl. 280/47.38; 280/250.1

(57) ABSTRACT

The invention relates to a small vehicle, particularly a wheel chair, comprising a chassis having a monocoque-type main body to which arms for supporting wheels are coupled and at which a seat component can be attached. The main body is designed as a monolith and preferably is manufactured from an extruded profile of aluminium or an aluminium alloy, or is made of wound sheet metal or of plastic. Four arms for two freely pivotable supporting wheels and two driving wheels are springably coupled to said main body.

### BACKGROUND OF THE INVENTION

The invention relates to a small vehicle, particularly a wheel chair comprising a chassis having a monocoque-type main body.

Wheel chairs, including those which are driven by a motor, usually comprise a wheel chair frame in which a seat is integrated, two wheels which can be driven and two wheels which can be either freely pivoted or steered by a motor wherein said wheels are directly coupled to said frame. The drivable wheels can be driven manually via hand rims or driven by a motor. Such wheel chairs often comprise a folding mechanism which allows folding of the wheel chair frame in order to reduce the overall size for the purpose of transport of the wheel chair. A wheel chair of this kind is for instance disclosed in EP 0 790 049 A2.

Wheel chairs of the kind as explained above are rather unsuitable for outdoor operation, that is for operation outside houses and particularly on uneven tracks, for instance tracks in fields or woods. The frame construction as described above has only a relatively low stability. Moreover, direct coupling of the wheels to a pipe frame only allows a suspension which is insufficient for uneven tracks since the only spring system is usually the one provided by the pneumatic tires.

Wheel chairs having acceptable driving and performance characteristics for outdoor operation are also known. However, the amount of time, work and effort needed for dismantling such wheel chairs for the purpose of transport is not acceptable.

There is a need for a small vehicle, particularly a wheel chair which has sufficient stability suitable also for outdoor operation as well as a drivability suitable for outdoor operation and, at the same time, can be dismantled so that transport thereof is possible in a typical trunk of an automobile.

### SUMMARY OF THE INVENTION

The small vehicle according to the present invention has a chassis having a monocoque-type main body. Four arms for supporting the wheels are springably coupled to the main body and a seat component is mounted at said main body. While according to the prior art discussed above a seat is integrated in a pipe frame and the wheels are directly coupled to said pipe frame, in case of the small vehicle according to the present invention the monocoque-type main body performs the function of supporting the suspension. The main body has sufficient stability to perform this supporting function.

The main body is designed as a monolith. This means that the main body has a block-like structure which provides sufficient stability, is relatively light weight and has corresponding attachment points for supporting the arms and for receiving the seat component. For this, the main body for example can be manufactured from an extruded profile, i.e. it can be provided in the form of a hard alloy extrusion or extruded shape made of aluminium or an aluminium alloy. Moreover, the main body can be made of a suitable plastic, a compound material, or of wound sheet metal.

Two freely pivotable wheels and two driving wheels can be detachably mounted at said at said arms, preferably by means of quick release devices. The driving wheels preferably comprise a hub motor, that is a motor which is provided in the region of the wheel hub. Accordingly, there is no necessity of providing a drive train from the vehicle frame to the driving wheels. The torque for driving the vehicle is provided in the hub motor and the stationary portion of the hub motor merely must be supported at the corresponding arm via a suitable support element to enable driving operation.

Electric motors are particularly suited for driving such small vehicles. Storage batteries necessary for power supply can be mounted at the main body, preferably via suitable quick release devices which allow quick and easy change of the storage batteries. Connection points for the storage batteries can be provided at opposite sides of the main body. Moreover, there can be provided several connecting points for selective operation with one or several storage batteries, wherein, in case the vehicle is to be operated with only one storage battery, this storage battery is mounted in a central position with respect to the center axis of the vehicle, while, if the vehicle is to be operated with several storage batteries, these storage batteries are mounted symmetrically with respect to the center axis of the vehicle.

The seat component of the small vehicle according to the present invention preferably comprises a seat, a back of seat and foot rests as well as two arm rests and is provided as a complete unit. This unit is adapted to be mounted to the main body and to be dismounted therefrom by means of a quick release device. The seat component can be foldable. Due to the modular structure of the small vehicle the seat can be designed with particular view to ergonomics so that also seat pans for seriously handicapped persons can be used. Moreover, the seat component can be rotatably arranged so that upon turning the seat by 180° a vehicle having rear wheel drive will become a vehicle which has front wheel drive.

The arms for supporting the freely pivotable wheels are preferably designed as springably supported dual arms. This ensures that the caster of the freely pivotable wheels remains essentially constant over the entire range of spring, particularly in case the freely pivotable wheels are coupled to the arms by means of plug-in axles which extend vertically to the ground. In case there is only a limited travel of the spring system, the front arms also can be designed as mono-arms.

The arms provided for supporting the driving wheels are preferably designed as longitudinally arranged arms which are supported at the main body via a spring/shock absorber unit.

A small vehicle designed as a wheel chair as explained above has excellent stability. The wheels may be springably supported to also allow operation on uneven tracks. At the same time, the structure and design of the wheel chair allow it to be dismantled into single components, making it possible to transport the wheel chair in the trunk of a common automobile. After the four wheels are detached from the arms, which for instance, can be done very easily if plug-in axles and quick release devices are used, and after the seat component and, as the case may be, storage batteries are removed, only the main body and the four arms, remain. This module unit has a flat shape which can be easily transported. The wheels and the storage batteries also can be easily stowed away and the seat component can also be brought into a space-saving flat form, if a folding mechanism is used.

Particularly in cases where electric motors are used as driving units, the main body can have interfaces for electric circuits at the connection points of the driving wheels and/or the seat component and/or the storage batteries. A control panel, including a console, can be provided at an arm rest of the seat component. Furthermore, it is possible to provide wireless signal transmission between the control panel and the driving wheels. If hub motors are provided, a separate control unit may be provided for each hub motor. In that case, it will not be necessary to provide wires for control signals. If the storage batteries are attached to the main body, it will only be necessary to provide power transmission to the hub motors.

If the storage batteries are also disposed adjacent the wheel hubs of the driving wheels and a wireless signal transmission for control signals is provided, it will not be necessary to provide any wires between the frame and the wheels.

### BRIEF DESCRIPTION OF THE DRAWINGS

In the following description, the invention is further explained in connection with a preferred embodiment making reference to the drawing in which

FIG. 1 is a perspective representation of a vehicle where the parts are taken apart in exploded view;

FIG. 2 is a perspective representation of the vehicle corresponding to FIG. 1 wherein the main components except a control panel are depicted as being assembled;

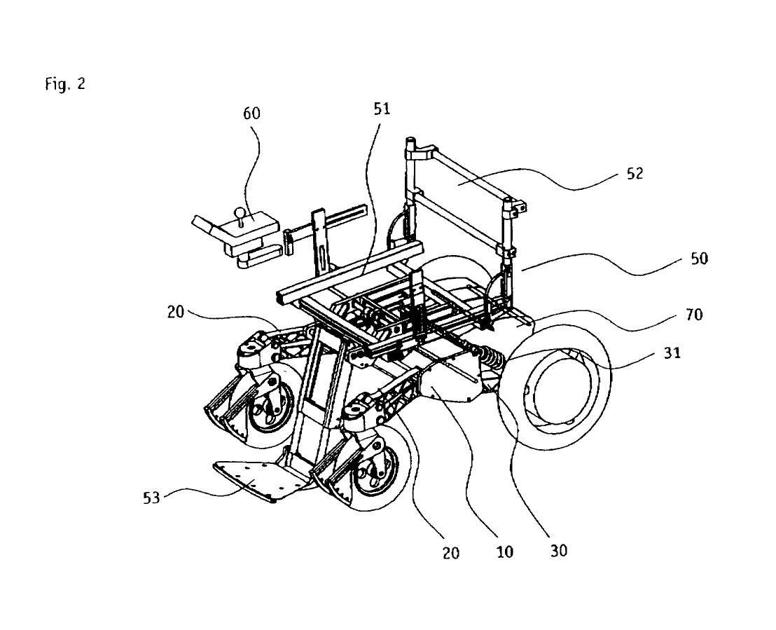

FIG. 3 is a perspective depiction of the wheel chair according to FIGS. 1 and 2 where the seat component is omitted;

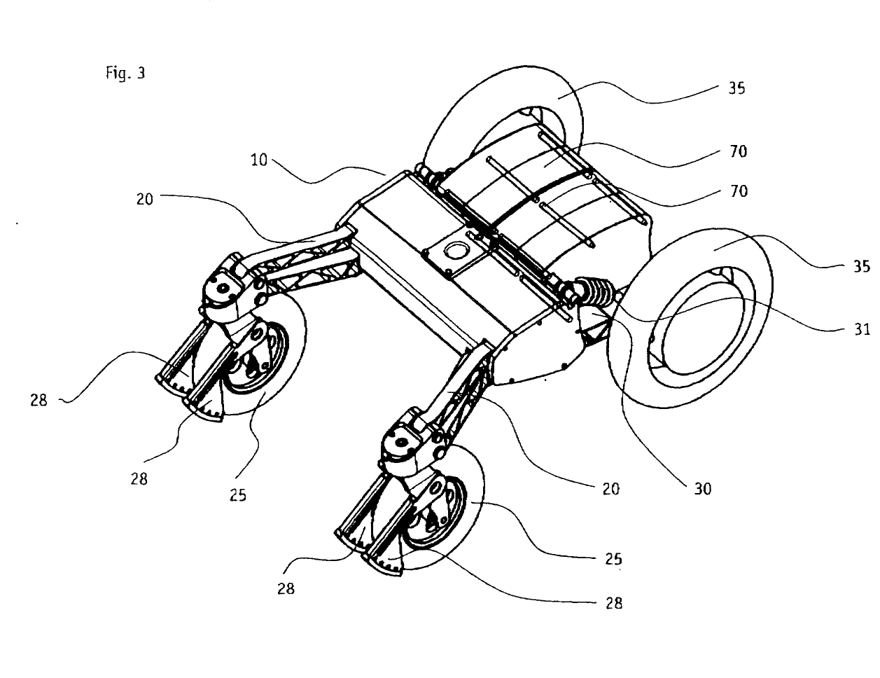

FIG. 4 is a depiction corresponding to FIG. 3 wherein an additional protective cage is attached;

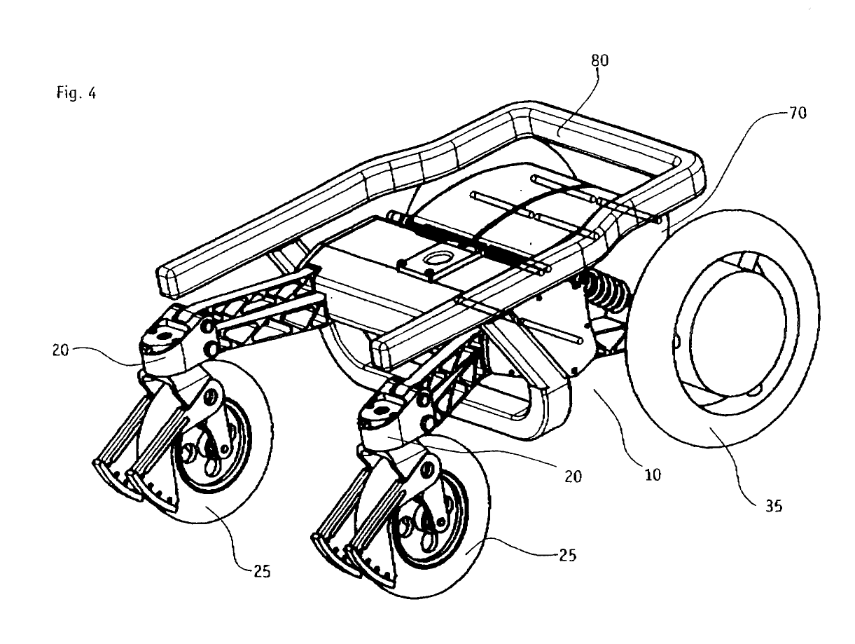

FIG. 5 is a side view of the representation according to FIG. 3;

FIG. 6 is a side view of a freely pivotable wheel having a climbing device in a position before a step is contacted; and

FIG. 7 is a representation corresponding to FIG. 6 in which a step is negotiated.

### DESCRIPTION OF PREFERRED EMBODIMENTS

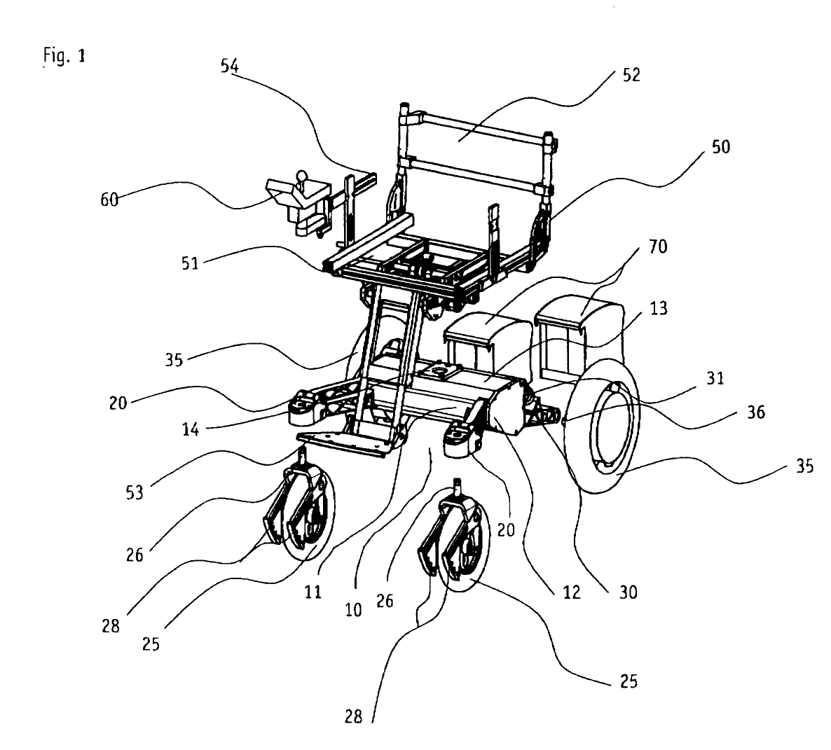

FIG. 1 shows a wheel chair as an embodiment of the present invention in a so-called exploded view, i.e. with the parts taken apart. The main body 10 is provided in the form of a hard alloy extrusion or extruded shape made of an aluminium alloy 11. The hard alloy extrusion 11 is closed at both longitudinal ends by corresponding end plates 12 and respective bolts. Internal reinforcing members (not shown) or other components, for instance switching units etc. (not shown) can be provided in the essentially hollow inner space of the main body 10. On the upper side 13 of the main body 10 there is provided a receiving unit 14 which serves for mounting of a seat component 50 by means of a quick release device which is not shown in detail.

The seat component 50 comprises frame profiles which together with fabric or upholstery provide a seat 51, a seat back 52, a foot rest 53 and a strut 54 for mounting control panel 60. It is understood that armrests (not shown) can be provided on both sides.

It is also clear that other structures are possible for the seat component; for instance, a seat and a seat back and, as the case may be, corresponding side parts. The whole seat component 50 can be provided as a monocoque structure and can have corresponding connecting elements for connecting the seat component to the main body or to a corresponding seat frame.

The seat component is provided with a folding mechanism which allows the seat component 50 to fold when it is detached from the main body 10 so that the seat can be easily transported as one element of substantially flat shape.

On the left side and on the right side, with reference to the driving direction of the vehicle, two front arms 20 and two rear arms 30, respectively, are connected to the main body 10. The rear arms 30 are designed as longitudinal arms which are supported at the main body 10 by means of a spring/shock absorber unit 31. The front arms 20 are designed as dual arms which are connected to each other by a spring/shock absorber mechanism which is disposed within the main body 10 and which is not shown in the drawings.

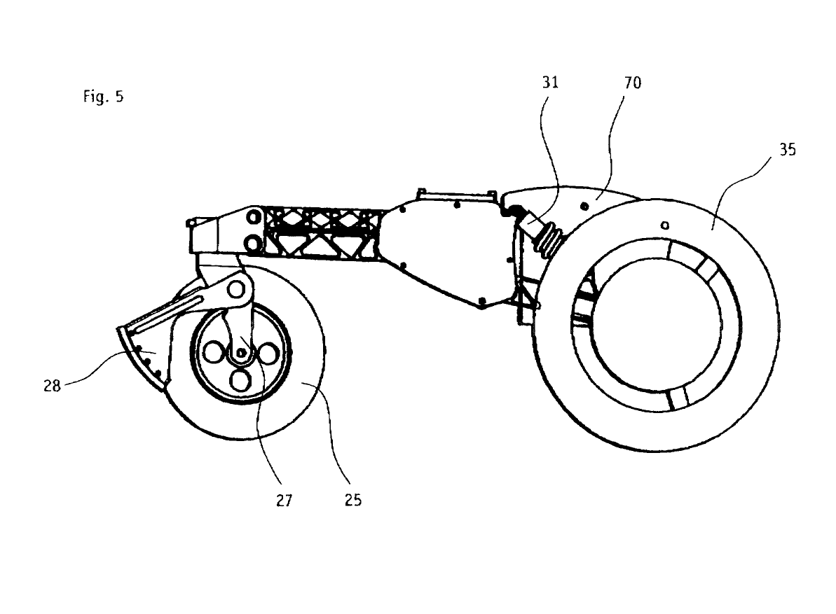

The two driving wheels 35 are coupled to the rear arms 30 via horizontally extending plug-in axles 36 and via quick release devices which are not shown in detail. Two front wheels 25, which are freely pivotable, are coupled to the front arms 20 via vertically extending plug-in axles 26 and via quick release devices which are also not shown in detail. As can be seen for instance from FIGS. 5 to 7, the position of the axis of rotation 27 of the front wheel 25 is offset with respect to the position of the plug-in axle 26. Consequently, a caster is provided so that the front wheels 25 are always oriented towards the driving direction when the vehicle is driving straight ahead. The steering of the wheel chair is effected by separate control of both driven rear wheels 35. Preferably, the driving force is provided by hub motors, i.e. electric motors which are provided in the hub region of the wheels (but are not shown in detail). Steering commands are input via a control panel 60.

The front arm 20 (illustrated as a dual arm) is designed in a way that the caster of the front wheel 25 remains substantially constant over the entire range of travel of the spring system.

One or several storage batteries 70 can be hooked to the main body 10 via quick release devices. The quick release devices for securing the storage batteries 70 comprise interfaces for electric circuits which provide electric connection of the storage batteries 70 to the hub motors.

A protection device in the form of a protective cage 80 is, preferably detachably, attached to the main body 10.

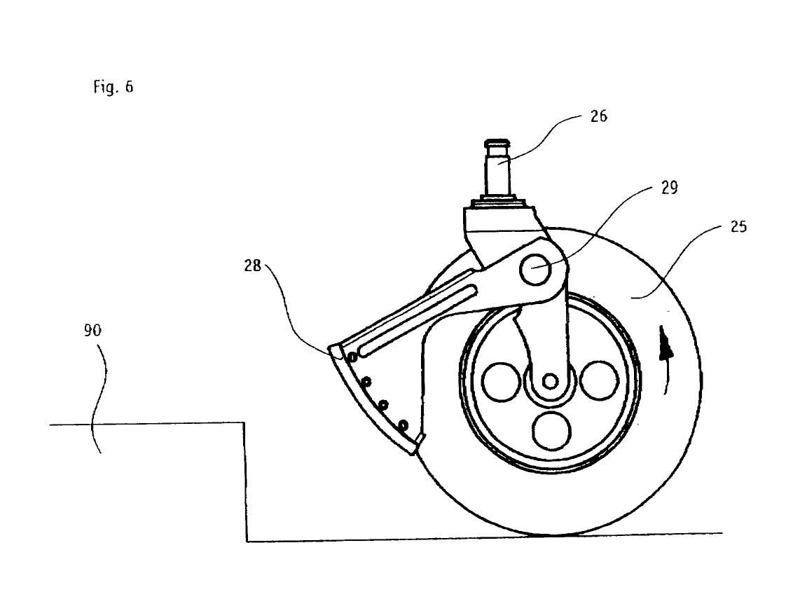

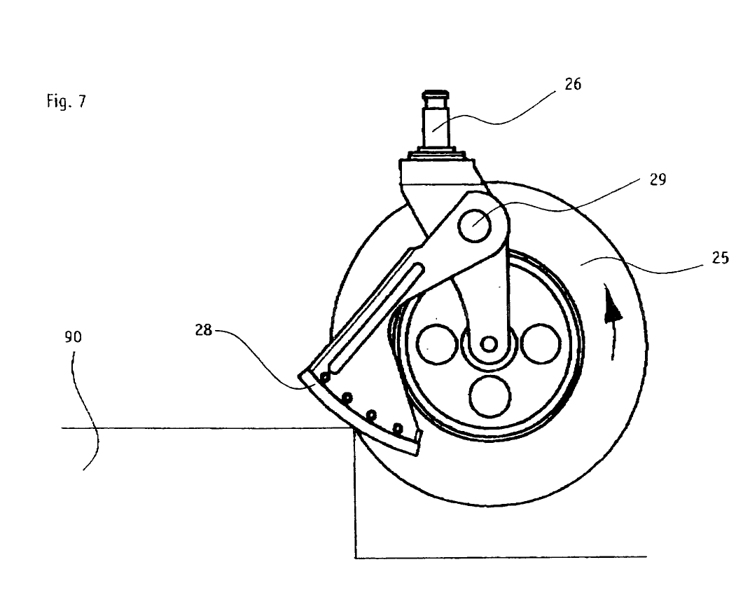

A climbing device 28 is provided at each of the front wheels 25. There is a pair of climbing devices 28 for each front wheel 25 which is supported on both sides of each front wheel 25 and biased in a way so that under normal operational conditions they are in a position which is depicted in FIG. 6. The climbing device 28 can be pivoted over a certain distance in the direction indicated by arrow A in FIGS. 6 and 7 in the direction of rotation of the wheel with the pivotal axis indicated at reference number 29.

For the sake of simplicity, only one front wheel 25 is depicted in FIGS. 6 and 7 in order to explain the function of the climbing device 28. When the wheel chair travels in the direction of a curb with the front wheel leading, the climbing device 28 initially is in its upper pivotal position due to the bias force of the spring. When the climbing device 28 gets in contact with curb 90, the climbing device 28 is pivoted in the direction of rotation of the front wheel 25 due to the driving force provided by the driving wheels. As a result, the front wheel 25 is lifted until it gets in contact with the curb in an appropriate position so that upon further travel of the vehicle the curb 90 can be negotiated.

Due to the fact that the climbing devices 28 are directly coupled to the freely rotatable front wheels 25, such climbing devices 28 are always in a suitable orientation with respect to an obstacle, particularly in such cases where a curb or another step is approached at an angle. It is clear that the climbing device also can be directly coupled to the main body.

The seat component 50, the storage batteries 70, the rear wheels 35 and the front wheels 25 can be removed by means of simple quick release devices for dismantling the wheel chair. After being removed, the seat component 50 can be folded. Accordingly, single components are provided which can be transported in a space-saving manner and which can be accommodated in the trunk of a common automobile. The ability to be easily dismantled further provides that the single components have a relatively low weight so chat the components can be easily stowed away. The provision of quick release devices facilitates dismantling of the wheel chair also for technically untalented persons and without any tools.

Even though the wheel chair of the present invention is easily dismantled, it is suitable for outdoor use. It combines the comfort of four spring-suspended wheels and the stability required for outdoor operation with the low weight and transportability of a common indoor wheel chair.

Although the invention has been described with reference to exemplary embodiments, it is not limited thereto. Rather, the appended claims should be construed to include other variants and embodiments of the invention which may be made by those skilled in the art without departing from the true spirit and scope of the present invention.

We claim:

1. A wheel chair comprising: a chassis having a monocoque-type main body designed as a monolith, four arms for supporting wheels are springably coupled to the main body; and the main body receives a seat component.

2. The wheel chair as claimed in claim 1, wherein the main body is made from an extruded profile.

3. The wheel chair as claimed in claim 1, wherein the main body is made of aluminium or an aluminium alloy.

4. The wheel chair as claimed in claim 1, wherein the main body is made of wound sheet metal.

5. The wheel chair as claimed in claim 1, wherein the main body is made of plastic.

6. The wheel chair according to claim 1, wherein two freely pivotable wheels and two driving wheels are provided.

7. The wheel chair according to claim 6, wherein said freely pivotable wheels and said driving wheels are detachably mounted at said arms via quick release devices.

8. The wheel chair according to claim 6, wherein said driving wheel has a hub motor.

9. The wheel chair according to claim 6, wherein said driving wheel is driven by an electric motor.

10. The wheel chair according to claim 1, wherein said seat component is detachably mounted at said main body via a quick release device.

11. The wheel chair according to claim 1, wherein one or several storage batteries are mounted on said main body.

12. The wheel chair according to claim 11, wherein said one or several storage batteries are mounted at one or both of two opposite sides of said main body.

13. The wheel chair according to claim 11, wherein one or several storage batteries are mounted on said main body, wherein, in case of operation with only one storage battery, the one storage battery is mounted in a central position with respect to a center axis of the vehicle, whereas, in case of operation with several storage batteries, the several storage batteries are mounted symmetrically with respect to the center axis of the vehicle.

14. The wheel chair according to claim 1, wherein said seat component comprises a seat, a seat back, at least one arm rest, and a foot rest, and the seat is detachably mounted on said main body as a complete unit via a quick release device.

15. The wheel chair according to claim 14, wherein said seat component is foldable.

16. The wheel chair according to claim 1, wherein said four arms comprise front arms for supporting pivotable wheels, and said front arms are designed as springably supported dual arms defining a caster of said pivotable wheels that remains substantially constant over the range of travel of a spring system defined by said springable coupling.

17. The wheel chair according to claim 7, wherein said quick release device for detachably mounting said pivotable wheel at a front arm, said quick release device comprises a plug-in axle extending perpendicular to the ground

18. The wheel chair according to claim 1, wherein said four arms comprise rear arms for supporting driving wheels, and said rear arms are designed as longitudinal arms which are supported at said main body via a spring/shock absorber unit.

19. The wheel chair according to claim 1, wherein said main body defines interface for electric circuits at mounting locations defined by the group consisting of mounting locations for driving wheels, said seat component, and storage batteries.

20. The wheel chair according to claim 1, wherein said seat component is mounted to said main body, said seat component being constructed as a body frame and having a monocoque construction, and the seat component being rotatable about 180°.

21. A wheel chair comprising:
a chassis having a monocoque-type main body designed for use as a single piece; four arms for supporting wheels, wherein the arms are springably coupled to the main body; and
the main body comprises a quick release for a seat component.

22. A wheel chair comprising:
a chassis having a monocoque-type main body designed for use as a single piece; four arms for supporting wheels, in which the arms are springably coupled to the main body; and
the main body supports a seat component.
